(19) United States
(12) Patent Application Publication
(10) Pub. No.: US 2011/0015609 A1
(43) Pub. Date: Jan. 20, 2011

(54) DRUG CONTAINER

(75) Inventor: Atsushi MATSUMOTO, Kanagawa (JP)

Correspondence Address: BUCHANAN, INGERSOLL & ROONEY PC, POST OFFICE BOX 1404, ALEXANDRIA, VA, 22313-1404, US

(73) Assignee: Terumo Kabushiki Kaisha, Shibuya-ku (JP)

(21) Appl. No.: 12/892,539

(22) Filed: Sep. 28, 2010

Related U.S. Application Data
(63) Continuation of application No. PCT/JP2009/055649, filed on Mar. 23, 2009.

(30) Foreign Application Priority Data
Mar. 28, 2008 (JP) 2008-088057

(51) Int. Cl. A61J 1/14

(52) U.S. Cl. 604/403

(57) ABSTRACT

In a drug container filled with a liquid drug, bubbles are formed during prolonged storage even in the case where the liquid drug is filled in a gas-free state after removing dissolved gas. With the container here, bubbles formed in the container during storage are removed and the formation of bubbles in the container is inhibited or prevented. A drug container, in which a liquid drug is enclosed, includes at least in part a resin member coming into contact with the liquid drug and a pressurizing member removable from the drug container, by which the liquid drug is maintained in a pressurized state, with the liquid drug being in a substantially bubble-free state.

This application is a continuation of International Application No. PCT/JP2009/055649 filed on Mar. 23, 2009, and claims priority to Japanese Application No. 2008-088057 filed on Mar. 28, 2008, the entire content of both of which is incorporated herein by reference.

### TECHNICAL FIELD

The present invention generally pertains to a container filled with a liquid drug, for use in storage and transportation of the liquid drug. More specifically, the invention involves a container and a prefilled syringe which eliminate the need to transfer a liquid drug into another injection implement at the time of use.

### BACKGROUND DISCUSSION

In recent years, concerns about contamination at the time of dissolution or transfer between containers have caused prefilled syringes having both a function as a container and a function as an injection implement to be used. A prefilled syringe, unlike a vial container, does not need transfer of a drug into an injection implement such as a syringe and a pump. Thus, the prefilled syringe is advantageous in that it can be used for injection immediately upon unsealing the syringe.

In relation to protein preparations such as insulin, containers have been developed which can, when set on an exclusive-use pump or injection implement with a gasket disposed at one end of the vial, be utilized for injection while preventing a solution in the container inside from making contact with the outside air.

In the case of a container utilized directly as an injection implement or a part thereof, as above-mentioned, concerns may arise about generating bubbles in the container during storage.

Normally, when a liquid-containing container is made of a gas-permeable material, for example a resin such as polypropylene frequently used for forming drug containers, bubbles are generated during prolonged storage. This is so even if a liquid drug is filled and stored in a gas-free state after removing dissolved gas from the container.

This arises from the fact that even if a liquid drug can be degassed to a substantially gas-free state when the liquid-containing container is filled with the liquid drug, external gas permeates through the resin constituting the container, and the gas brought to supersaturation due to a temperature variation during storage evolves as bubbles inside the container.

This phenomenon occurs to some degree in the use of water as a solvent, since such gases as oxygen and nitrogen are dissolved in water. Therefore, the phenomenon can occur in drugs using water as a solvent.

The bubbles are discharged before using a prefilled syringe, which is used for injection or pump injection immediately upon unsealing, so that operations for using such a prefilled syringe are more involved or intricate.

In the cases of drugs to be injected in extremely small amounts such as an insulin preparation, mixing-in of bubbles may lead to an insufficient dose or compression of bubbles under pressure may lead to an inaccurate ejection amount.

In addition, where a water-soluble protein preparation is stored and transported in a solution state, a condition where the container is not filled up with the liquid, that is, a condition where a gas region or bubbles are present inside the container, produces the following problem. The aqueous solution is stirred due for example to vibrations during transportation, and the surface tension of bubbles exerts a load on the molecular structure of the protein, whereby denaturation (degeneration) of the protein is promoted and the preservability is worsened.

For preventing such denaturation, in the case of an insulin container to be used in the state of being set on the above-mentioned exclusive-use pump or injection implement, the insulin should be placed in a gas-impermeable glass container in a gas-free state and should be stored at a low temperature and in a condition where the temperature is little varied.

Since such a liquid drug container is used in the state of direct connection with a pump or injection implement, however, a resin seal (gasket) slidable while keeping a liquid-tight sealed state between itself and the liquid drug container is needed for pushing the liquid drug out of the container. In addition, other components such as a resin septum to be penetrated by a connection end part of an injection needle or a connection needle constituting a route of ejection of the liquid drug from the liquid drug container are needed. Accordingly, it has been impossible to substantially prevent the generation of bubbles which might arise from penetration of the outside air into a liquid drug container.

### SUMMARY

The system disclosed here stores a liquid drug in a pressurized state, thereby removing gaseous components through a resin constituting a part of a drug container, and helping ensure that the drug container filled with the liquid drug can be used in a bubble-free condition.

It has been discovered that by putting the liquid drug in a predetermined pressurized state, it is possible to inhibit or prevent the problem that a gas having entered into a container by permeating through a resin constituting a wall part of the container might be supersaturated under temperature variations during storage, to form bubbles in the container. And even if bubbles should form in the container during storage, the container and method disclosed here remove or eliminate the bubbles.

According to one aspect, a drug container comprises: a container possessing an interior enclosing a liquid drug, with at least a part of the container being a resin part in contact with the liquid drug; a pressurizing member mounted in the interior of the container, with the pressurizing member being operable to maintain the liquid drug in the interior of the container in a pressurized state and being removable from the container, whereby the liquid drug is in a substantially bubble-free state.

The drug container having the resin member is provided with the removable pressurizing member. This makes it possible to remove the bubbles present in the drug container to the exterior of the container and to dissolve the bubbles into the liquid drug.

The drug container can include an outer tube having a tip and a rear end, and a seal slidable on an inner surface of the outer tube in an axial direction of the outer tube, with the tip being sealed with a sealing member. At least one of the seal and the outer tube includes the resin member, and the liquid drug is in the outer tube between the sealing member and the seal.

Thus, in the drug container having the resin member, the liquid drug is filled between the sealing member and the seal. This permits the drug container disclosed here to be used as a prefilled syringe.

The container can be configured to include a plunger extending from the rear end side of the outer tube and having a tip part and a rear end part, with the tip part connected to the seal, and the rear end part having a pressing part. The pressurizing member can be in the form of an elastic member removably mounted at the surface of a flange of the outer tube and a surface of the pressing part to apply a compressive force between the flange and the pressing part.

With these features, the flange of the syringe and the plunger are clamped or pressed together, with a compressive force between the two. This helps ensure that the drug container capable of producing desirable results disclosed here can be fabricated as a prefilled syringe with a relatively simple configuration.

According to one possibility, the pressurizing member includes an elastic member which has a fixation part for fixation to the outer tube and which is detachably attached to the seal.

With this construction, the pressurizing member is provided with the fixation part and the elastic member detachably attached to the seal. This permits the drug container to be used as an insulin injection device, such as an insulin pen.

According to another possibility, the pressurizing member has a fixation part for fixation to the outer tube, and maintains the liquid drug in a pressurized state through pressing of an elastic member of the seal provided with the elastic member. Thus, the pressurizing member presses the elastic member provided in the seal. This permits the drug container to be used as an insulin injection device, such as an insulin pen.

The liquid drug is preferably maintained in a pressurized state in which the internal pressure under which the container interior is maintained is 10 kPa to 90 kPa. With such a configuration, the condition where bubbles are absent in the drug container can be attained more securely.

According to the disclosure here, a liquid drug can be stored while maintaining the liquid drug in a pressurized state until immediately before use of the liquid drug, and penetration of gas through a resin member constituting the container or part of the container can be inhibited or prevented from occurring during storage. Consequently, it is possible to provide a drug container containing a liquid drug which is substantially bubble-free.

In addition, the liquid drug is stored in a pressurized state by a pressurizing member by which a seal (gasket) is held in a pressurized state, and bubbles in the drug container are removed to the exterior of the container and dissolved into the liquid drug, whereby a drug container with substantially no bubbles present can be provided.

According to another aspect, a drug container comprises: a tubular member possessing an interior, a rear end pat and a tip end part, the tip end part being a closed tip end part, a seal positioned in the interior of the tubular member and slidably engaging an inner surface of the interior tubular member in a liquid-tight manner, a liquid drug in the interior of the tubular member wholly between the closed tip end part and the seal, at least a part of the tubular member being a resin part which is continuously in contact with the liquid drug, and means for pressing the seal in a direction toward the closed tip end part of the tubular member to maintain the liquid drug in the interior of the container in a pressurized state of at least 10 kPa so the liquid drug is in a substantially bubble-free state during storage.

Another aspect of the disclosure here involves a method of storing a liquid drug in a drug container to eliminate bubbles and inhibit bubble formation during storage. The drug container includes a container possessing an interior enclosing a liquid drug, with at least a part of the container being a resin part in contact with the liquid drug, and a seal positioned in a liquid tight manner in the interior of the container and slidable along an inner surface of the interior of the container. The method comprises: pressurizing the interior of the container containing the liquid drug so the liquid drug in the interior of the container is maintained in a pressurized state to eliminate bubbles and inhibit bubble formation during storage; and storing the drug container containing the liquid drug in the pressurized state.

### BRIEF DESCRIPTION OF THE DRAWING FIGURES

FIG. 1 is a perspective view of one embodiment of a prefilled syringe disclosed here.

FIG. 2 is a plan view of the prefilled syringe shown in FIG. 1, with the tip section of the syringe shown in a cut-away cross-sectional view.

FIG. 3 is a cross-sectional view of a spring member used in the prefilled syringe of FIG. 1.

FIG. 4 is a cross-sectional view of a part of the spring member of the prefilled syringe of FIG. 1, in a mounted state.

FIG. 5 is a cross-sectional view of a part of the spring member of the prefilled syringe of FIG. 1, in a dismounted state.

FIG. 6 is a cross-sectional view of a container for connection to a device, before fitting of a fixing cap according to a second embodiment disclosed here.

FIG. 7 is a cross-sectional view of the container for connection to a device, after fitting of the fixing cap according to the embodiment shown in FIG. 6.

FIG. 8 is a cross-sectional view of the container for connection to a device, before fitting of a fixing cap according to a modification of the second embodiment.

FIG. 9 is a cross-sectional view of the container for connection to a device shown in FIG. 8 after fitting of the fixing cap.

FIG. 10 illustrates a measuring apparatus used in Experimental Examples.

FIG. 11 a graph showing variations in pressure before correction made each day, for a syringe with a preset pressure of 10 kPa in Experimental Example 2.

### DETAILED DESCRIPTION

The container disclosed here is one in which a liquid drug is enclosed and which is provided at least in a part with a resin member contacting the liquid drug with the liquid drug in the drug container maintained in a pressurized state until immediately before use, by a pressurizing member which is removable from the drug container and operable to maintain the liquid drug in the drug container in a pressurized state, so that the liquid drug in the drug container can be used in a substantially bubble-free state.

The liquid drug which is contained in the container disclosed here is an aqueous liquid obtained through dissolution, dispersion or the like of a drug in water.

In general, resin materials exhibit a property of permitting gases such as oxygen, nitrogen, etc. to permeate through the resin material by dissolution and diffusion. The container disclosed here utilizes this property.

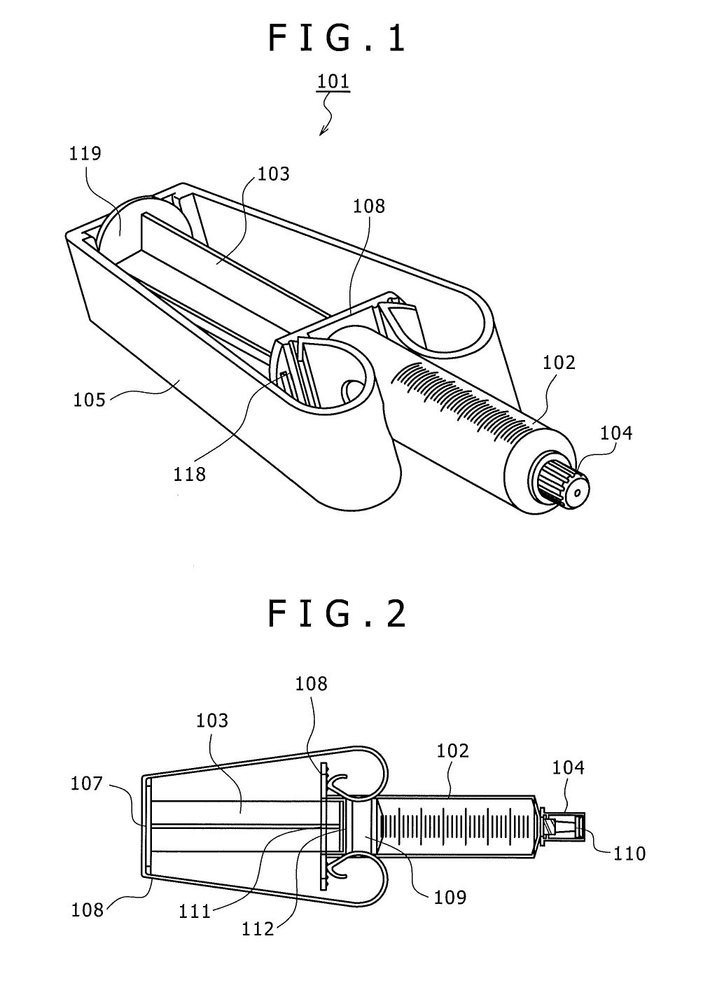

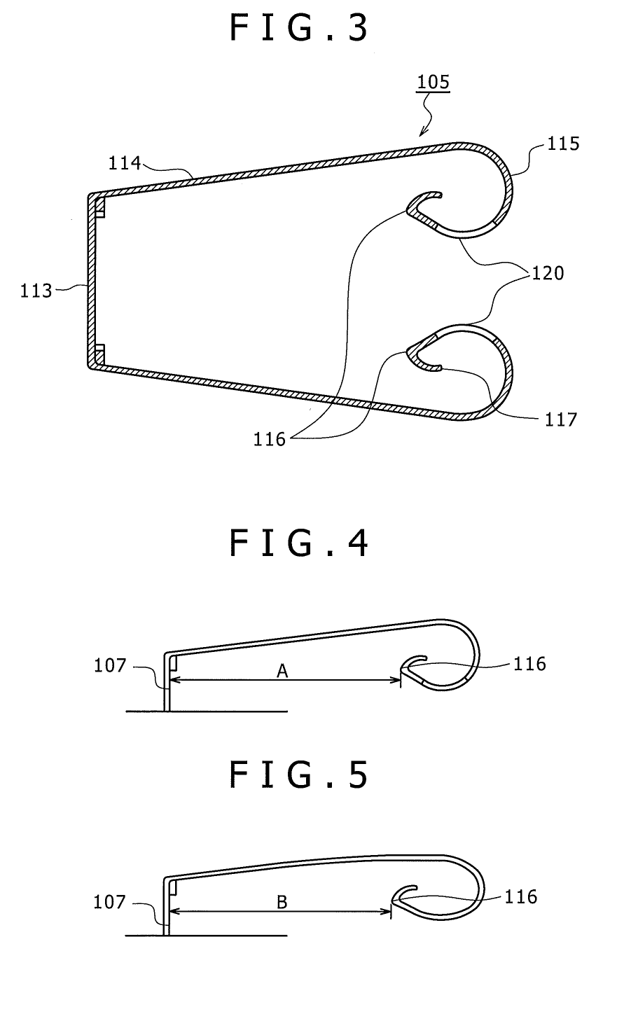

One example of the container disclosed here is illustrated in FIGS. 1-5 and involves a prefilled syringe 101.

The prefilled syringe 101 includes a cylindrical outer tube 102 made of a resin, a resin gasket 109 contained in the outer tube 102 and serving as a seal performing a sealing function while being slidable in a liquid-tight manner in relation to the inner surface of the outer tube 102, a plunger 103 extending from a rear end opening 111 of the outer tube 102 and attached to or attachable to the gasket 109, a cap 104 for sealing a tip opening 110 of the outer tube 102, and a spring member 105 formed of an elastic material for pressurizing a liquid drug in the outer tube 102. The resin outer tube 102 is in contact (continuously in contact) with the liquid drug as long as the ends of the outer tube are closed. The plunger is an engaging member which engages the seal or gasket 109. An outwardly directed flange 108 extending in the circumferential direction of the outer tube 102 is provided at the rear end opening 111 of the outer tube 102.

The prefilled syringe 101 can eject the liquid drug in the outer tube by removing the cap 104 and pushing the plunger 103 toward the tip opening 110 (i.e., in the distal or forward direction). In addition, where a rubber disk which can be pierced by a needle into the prefilled syringe 101 in a liquid-tight manner is provided at the tip opening 110 of the outer tube 102, the liquid drug can be ejected by use of a double ended needle.

The liquid drug inside the prefilled syringe 101 is isolated from the exterior by the outer tube 102, the gasket 109 and the cap 104.

The spring member 105 (pressurizing member) is made of a substantially angular U-shaped elastic member, and includes a flat central part 113, intermediate parts 114 bent at both end portions of the central part 113 and gently curved, curved parts 115 each curved from the intermediate part 114 toward the inside of the angular U-shape in a substantially arcuate shape, presser parts 116 each continuous with the curved part 115 and having an outer surface facing the central part 113, and terminal end parts 117 each curved from the presser part 116 so as to extend away from the central part 113. The presser parts 116 are each engaged with a rugged part 118 provided at that surface of the flange 108 which faces towards the tip of the syringe, and an inside surface of the central part 113 abuts on the pressing part 119 of the plunger 103 to form a lock part 107. The distance between the central part 113 and the presser part 116 in the syringe axial direction determined by the intermediate part 114 and the curved part 115 is shorter than the distance between the proximally facing surface of the presser part 119 and the distally facing surface of the flange 108 (i.e., the surface of the presser part 119 on the tip side) when a predetermined amount of a liquid drug is contained in the outer tube 102. With this setting, the spring member 105 is mounted to the pressing part 119 and the flange 108 while deforming the intermediate parts 114 and the curved parts 115, whereby the spring member 105 generates a force pushing the plunger 103 toward the syringe tip side (i.e., in the distal direction). As a result, an internal pressure is generated in the liquid drug contained in the prefilled syringe 101. The pressing force (pressure) can be varied by regulating the shape and/or material of the spring member 105 and the position of its engagement with the flange 108. In addition, providing each curved part 115 with a hole 120 in the portion of the curved part 115 making contact with the outer tube 102 results in a portion of the side surface of the outer tube 102 entering the holes 120 in the curved parts 115, and the intermediate parts 114 shifting toward the inside of the angular U shape. Thus, the area occupied by the prefilled syringe 101 in the condition where the spring member 105 is mounted can be reduced.

FIGS. 4 and 5 show a part of the spring member 105, in the condition where it is mounted to the prefilled syringe 101 and in the condition where it is dismounted from the prefilled syringe 101, respectively. In the condition where the spring member is dismounted from the prefilled syringe 101 (FIG. 5), no load is exerted on the spring member. In this condition, the axial distance B between the presser part 116 and the lock part 107 of the spring member 105 is shorter than the axial distance A between the presser part 116 and the lock part 107 in the condition where the spring member 105 is mounted to the prefilled syringe 101 (FIG. 4).

As a result, in the condition where the spring member 105 is mounted on the prefilled syringe 101, a force for returning the axial distance between the presser part 116 and the lock part 107 to B is generated in the spring member 105. By virtue of this force, the spring member 105 exerts a compressive force on the liquid drug inside the syringe outer tube 102 from the gasket 109 through the plunger 103.

In using the prefilled syringe 101, the spring member 105 in this shape is rotated in the circumferential direction of the outer tube 102, with the moving direction of the plunger 103 as an axis of rotation, whereby the presser parts 116 are disengaged from the flange 108 and the spring member 105 can be relatively easily removed.

Examples of the material which can be used for the spring member 105 include elastically deformable plastics such as polyethylene, polypropylene, polyvinyl chloride, polyurethane, etc. Also, metallic materials such as stainless steel may also be used insofar as they are elastically deformable.

In addition, the spring member used here is required only to generate a force for constantly pressing the plunger 102. Therefore, the shape and structure of the spring member are not limited to those in this embodiment, and various configurations may be contemplated. As an example, a configuration is possible in which the flange 108 and the pressing part 119 are tied together by a rubber. In that case, examples of the material which can be used for the spring member include rubbers such as silicone rubber, urethane rubber, fluoro-rubber, etc. and various elastomers based on olefin, nylon or urethane.

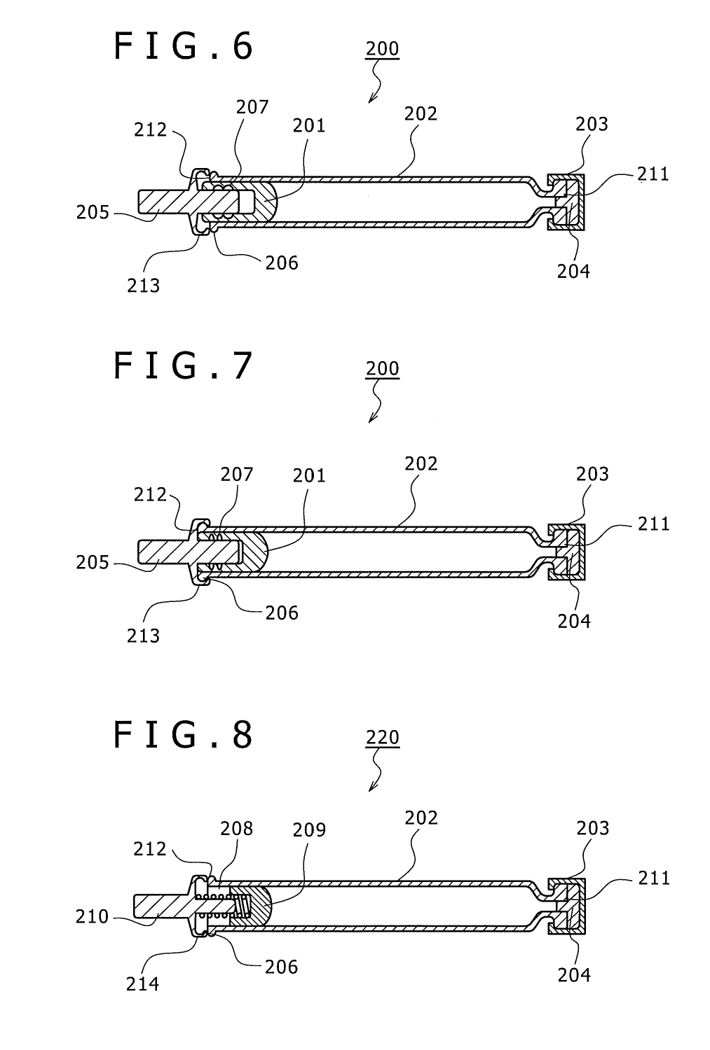

FIGS. 6-9 show a container for connection to an ejection device, which is one example of a second embodiment disclosed here.

FIGS. 6 and 7 illustrate an example of application of the disclosure here to a cartridge to be connected to an insulin injection device (described in U.S. Pat. Nos. 5,295,976 and 5,271,527, or the like, the disclosure of which is incorporated herein by reference) such as an insulin pen.

A cartridge 200 includes a glass-made cylindrical glass vial 202 opening at a tip part 211 and a rear end part 212, a resin gasket or seal 201 contained in the glass vial 202 and having both a spring part 207 (a part of the gasket or seal exhibiting elastic or springy characteristics) and a sealing aspect in which the gasket is slidable in a liquid-tight manner in relation to the inner surface of the glass vial 202, a fixing cap 205 detachably attached to the gasket 201 and disengageably engaged with the rear end part 212, a rubber septum 204 is a sealing member sealing the opening at the tip part 211 of the vial 202, and an aluminum cap 203 for maintaining a liquid-tight sealed state of the rubber septum 204 relative to the glass vial 202. The fixing cap 205 acts as an engaging member which engages the seal or gasket 201. The glass vial 202 also has a rib 206 projecting from the rear end part 212 in the circumferential direction. The resin seal 201 is in contact (continuously in contact) with the liquid drug as long as the ends of the tubular member 202 are closed.

The rear end part side 212 of the gasket 201 is provided with the spring part 207 which is slidably engaged with the fixing cap and exhibits rubber elasticity. The spring part 207 is designed in such a manner that, when the gasket 201 is so mounted that the cartridge 200 is filled up with a liquid drug so as to leave no gas region in the cartridge 200, the rear end of the spring part 207 extends from the opening at the rear end part 212 of the glass vial 202, as shown in FIG. 6.

The fixing cap 205 has a flange joint 213 which fits onto the rib 206, and a part slidably engaged with the spring part 207. With the flange joint 213 pushed so as to fit onto the rib 206 as shown in FIG. 7, the spring part 207 is deformed in compression, generating a force for pushing the gasket 201 toward the tip part (opposite end) 211. As a result, pressure can always be exerted on the liquid drug inside the cartridge 200. In other words, in this embodiment, a combination of the spring part 207 and the fixing cap 205 constitutes a pressurizing member.

The cartridge 200 is connected to an injection device by a method in which before mounting to a device such as a pump, the fixing cap 205 is removed and, thereafter, a central portion of the aluminum cap 203 for fixing the rubber septum 204 is peeled off so as to permit a needle to pierce the rubber septum 204. Therefore, the pressure inside the cartridge 200 has already been released at the time of mounting to the injection device, so that the liquid drug does not jet out of the cartridge 200 at the time of mounting.

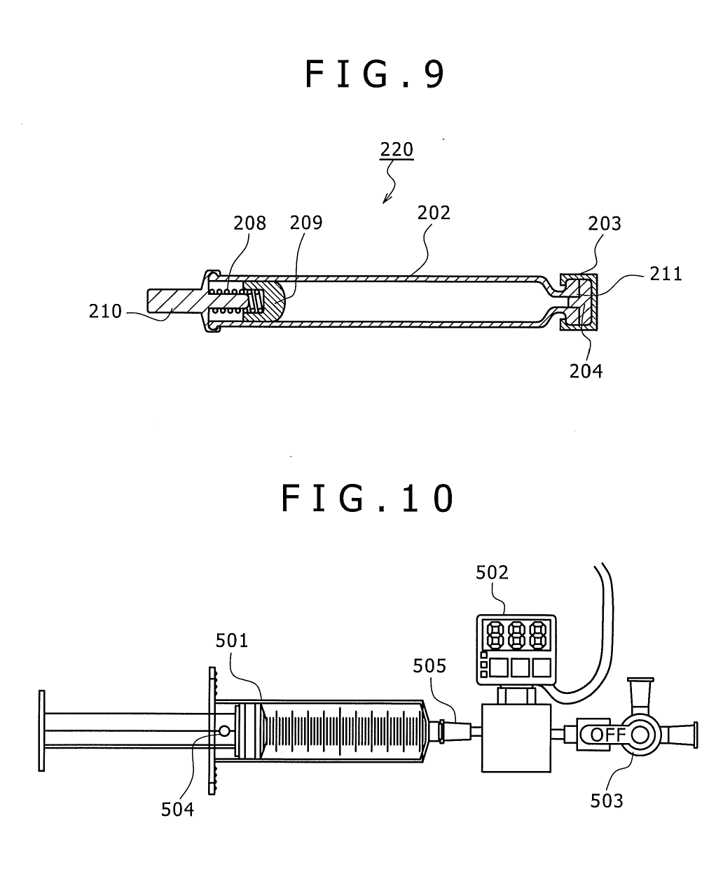

FIGS. 8 and 9 illustrate a partial modification of the above-described second embodiment. A cartridge 220 in this embodiment differs from the above-described cartridge 200 in the configuration of the pressurizing member for exerting a compressive force on the liquid drug. A spring part 208 in this modification including a spring which is disposed between a gasket 209 and a fixing cap 210, is formed from an elastic material and is removable from the gasket 209. In other words, the pressurizing member in this modification is constituted of a combination of the spring member 208 separated from the gasket 209 with the fixing cap 210. With the configuration in this modification, also, an effect equivalent to that of the gasket 201 in the above-described embodiment can be attained. In the gasket 201, the gasket (seal) and the spring part (a part of the pressurizing member) are integral with each other; on the other hand, in this modification, the gasket 209 is separate from the spring part (a part of the pressurizing member). The former permits a reduction in the number of component parts, and is relatively easy to assemble.

The material forming the drug container can be a suitable material selected according to the kind of liquid drug with which the container is filled. Desirably, a material which does not affect the compositions of the liquid drug and additives during storage is used.

For instance, in the case where a liposoluble vitamin compound or phenol ordinarily added to insulin as a combined preservative and stabilizer or the like is contained in the drug to be enclosed in the drug container, use of polypropylene, which is generally used as material of containers, may lead to adsorption of the drug components onto the inside wall of the container or diffusion of the drug components into the outside air. Thus, there arises a need to change the material of the container according to the kind of liquid agent with which the container is filled.

As described above, it is quite difficult for the resin components such as plastics or rubbers to be perfectly impermeable to oxygen or nitrogen molecules. The container disclosed here can offer the desired effect if a resin component is used in a part of the container, and it is possible to cope with changes associated with the kind of material for the main body of the drug container according to the above-mentioned requirements.

For example, even in the case where the container body is made of a perfectly gas-impermeable glass, as shown in FIG. 6, the gasket 201 and the rubber septum 204 are made of resin, so that gas exchange can be made between the inside of the container and the outside air. Consequently, a liquid drug can be stored in the container in such a manner as to prevent generation of bubbles as mentioned above.

Thus, it suffices that the blank material of the container (hard material of the container) disclosed here is provided at least in a part with a material permitting diffusion therethrough of atmospheric gases such as oxygen and nitrogen.

Examples of the blank material which can be used for forming a hard part of the drug container include polyethylene, polypropylene, cyclic polyolefin, polyethylene terephthalate, polybutylene terephthalate, polymethylpentene-1, mixtures thereof, and admixtures thereof with a softening agent such as SEBS.

Preferable examples of material for the gasket (seal) part and the septum include silicone rubber, flexible polyolefin admixed with a styrene elastomer such as SEBS, etc., butyl rubber, and so on, to which carbon black or ceramic may be added.

Where the above-mentioned blank material is used in a part of the drug container so as to be interposed between the liquid drug and the outside air, it is also possible to use glasses, ceramics, and metals such as stainless steel.

In the container disclosed here, the pressure to be loaded on the liquid drug differs depending on various conditions, such as the blank material and structure of the container, the amount of dissolved gas in the liquid drug and temperature at the time of filling the container with the liquid drug, and how much time it may take for the bubbles generated after filling to disappear.

In the cases of prefilled syringes having a syringe outer tube made of polypropylene, which is used for those prefilled syringes and ordinary syringes which are commercially available at the time of development of the container disclosed here, in general, a pressure of not less than 25 kPa is preferable for causing bubbles to disappear during storage at room temperature.

In the case where the dissolved gas upon filling is removed or where heating to 50° C. or above can be performed after filling, however, a pressure of about 10 kPa is sufficient for preventing generation of bubbles, or for removing generated bubbles and storing the liquid drug in a bubble-free state.

In addition, where the drug container undergoes an autoclave sterilization step, the solubility of gas is lowered at high temperatures and, simultaneously, the partial pressures of atmospheric air components such as oxygen gas and nitrogen gas can be lowered. Consequently, the amount of dissolved gas in the liquid drug can be reduced.

Therefore, with a pressure preliminarily loaded on the liquid drug at the time of autoclave sterilization, it is possible, even by application of a low pressure, to remove gas present in the liquid drug, to put the liquid drug into a state of containing less dissolved gas upon cooling, and to store the liquid drug without generation of bubbles.

In the case of a protein preparation such as insulin, if a liquid drug before aseptic filling is decompressed through a gas exchange membrane to remove dissolved gas therefrom and thereafter filling is conducted and the liquid drug is stored at a temperature of below 10° C., even application of a pressure of about 5 kPa is sufficient for storing the liquid drug without generation of bubbles.

However, even in the case of a protein preparation, the drug is normally used at room temperature. Therefore, even in the case of a liquid drug stored at a low temperature, it is preferable to store the liquid drug under an applied pressure of not less than 10 kPa.

Now, advantageous aspects of the container disclosed here will be described below referring to experimental examples. The liquid drug used in the experimental examples was selected to show a condition where bubbles are liable to be generated. Specifically, ultrafiltered water left to stand for at least one day with occasional stirring in a 4° C. cold storage in the condition where a gas-liquid interface was present (hereinafter referred to as “cold-stored water”) was used as a liquid drug model.

### Experimental Example 1

FIG. 10 illustrates a measuring apparatus used in the experimental examples.

A commercial available 10 ml (this expression refers to the state of being commercialized as a product for a 10 ml capacity) polypropylene syringe 501 (Terumo Syringe, a product by Terumo Corporation) was filled with water having been stored with cooling at 4° C., in the manner of not leaving any gas region inside the syringe 501. Further, a pressure gauge 502 (PG-35, a product by Nidec Copal Corporation) was connected to the syringe 501 through a Luer connector 505.

A gasket of this commercial syringe is formed of a flexible polyolefin elastomer admixed with a styrene elastomer.

The plunger was fixed by a plunger fixing pin 504 so that the position of the plunger relative to an outer tube is kept unchanged, whereby the pressure exerted on the water was prevented from being lowered due to movement of the gasket. Auxiliary parts other than the syringe, such as the pressure gauge 502 and a pressure regulation port 503, were formed from brass or stainless steel so as to prevent penetration of gas through the auxiliary parts, and the inside of the auxiliary parts was filled up with water.

An initial pressure was set by pouring the water into the syringe through the pressure regulation port 503, the syringe 501 was left to stand for 1 hr in a 50° C. oven, and thereafter the presence or absence of bubbles inside the syringe 501 was visually checked. The results are shown in Table 1.

TABLE 1
Generation of bubbles during storage at
50° C. in 10 ml polypropylene syringe

| | |
|---|---|
| Initial | After 1 hr at 50° C. |

| pressure | Pressure | Confirmation |
|---|---|---|
| (kPa) | (kPa) | of bubbles |
| 0.1 | 20.1 | present |
| 10.0 | 23 | present |
| 15.2 | 28.6 | present |
| 20.0 | 36.2 | present |
| 25.6 | 26.8 | present |

From the results of Experimental Example 1, it was confirmed that the storage at 50° C. raised the pressure inside each syringe to 20 kPa or above, resulting in generation of bubbles in all the syringes. This shows that the pressure rise is caused by a phenomenon in which the solubility of dissolved gas is lowered due to the temperature rise and bubbles are thereby generated.

### Experimental Example 2

The same syringes as above were treated and measurement was conducted in the same measuring conditions as in Experimental Example 1, except that the internal pressure was regulated to a preset value after the lapse of 1 hr from transfer into the 50° C. oven and, thereafter, the water-filled syringes were stored for a long time while correcting the pressure to the preset value every day. The results are shown in Table 2.

TABLE 2
Change of bubbles with time at 50° C.

| | At pressure confirmation and correction | | | |
|---|---|---|---|---|
| Preset | after storage at 50° C. | | | Confirmation of |
| pressure | Max-P | Min-P | Av | disappearance of |
| (kPa) | (kPa) | (kPa) | (kPa) ± SD | bubbles |
| 0 | 9.6 | 1.3 | 4.0 ± 2.3 | Not disappeared in 2 |
| | | | | weeks |
| 10 | 14.4 | 2.5 | 8.4 ± 2.6 | Not disappeared in 2 |
| | | | | weeks |
| 20 | 20.5 | 10.0 | 16.0 ± 2.6 | Disappeared in 8 days |
| 27 | 23.3 | 22.7 | 23.0 ± 0.4 | Disappeared in 2 days |
| 30 | 26.5 | 14.8 | 20.8 ± 5.7 | Disappeared in 2 days |

From the results of Experimental Example 2, it was confirmed that bubbles inside the syringes disappear when a pressure of not less than 20 kPa is continuously exerted on the aqueous liquid in the syringes. It was also confirmed that the rate of disappearance of bubbles increases as the pressure is raised, and that it is possible by raising the pressure to cause disappearance of bubbles in about two days.

Even when the preset pressure was 20 kPa, for example, the pressure would be lowered over time. In the measuring apparatus shown in FIG. 10 used in the experimental examples, generation or disappearance of extremely little bubbles could even be detected as pressure changes with good sensitivity, since the syringes had a substantially constant internal volume.

Accordingly, this lowering in pressure can be considered to be due to release of gas component out of the syringes.

Where no pressure is exerted, on the other hand, the pressure inside the container is somewhat raised due to generation of bubbles. It can be understood, however, that it is difficult for the bubbles to disappear under this pressure rise.

Specifically, the foregoing shows that, at a syringe internal pressure of about 10 kPa, the diffusion of gas molecules toward the inside of the syringe and the diffusion of the gas molecules toward the outside of the syringe are in such a relation that the gas diffusion toward the outside of the syringe is not predominant, and, therefore, bubbles do not disappear. It is also shown that when the pressure is further raised to 20 kPa, on the other hand, the release of gas from the inside of the syringe into the atmosphere, or the gas diffusion toward the outside of the syringe, becomes predominant. Thus, the following can be said. If transpiration of water inside the syringe into the atmosphere does not occur, that is, if the species exchanged through the resin wall surfaces are only such gas components as oxygen and nitrogen molecules, a condition where the pressure inside the syringe becomes substantially constant over time is a condition where the amount of gas components diffused toward the inside of the syringe and those toward the outside of the syringe are balanced.

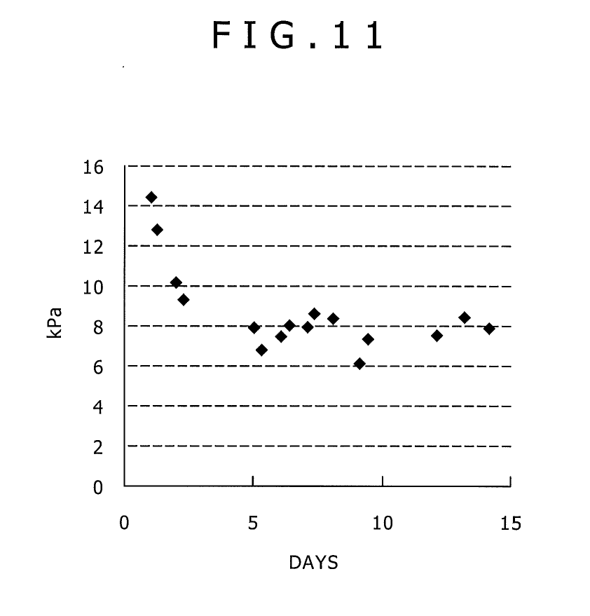

In the case where a pressure of 10 kPa is exerted on water, the pressure at the time of correction varies as shown in FIG. 11. Immediately after the start of the test, generation of bubbles was present, and the pressure at the time of correction was above 10 kPa. On the other hand, after several days, a constant pressure value was attained which was around 8 kPa and approximate to the preset pressure. This shows that a pressure of about 8 to 10 kPa is the pressure at which the amount of gas diffused toward the outside of the syringe and the amount of gas diffused toward the inside of the syringe are balanced.

However, even in the case of polypropylene, which has a low water vapor permeability, the rate of permeation of water vapor is not 0 (zero). In other words, the volume of water in a syringe made of polypropylene decreases with time, and the pressure is also liable to be lowered according to the decrease in the volume of water inside the syringe. Accordingly, the above-mentioned pressure at which the rates of diffusion of gas components other than water, such as dissolved oxygen and nitrogen, toward the outside of the syringe and the rates of diffusion of the gas components toward the inside of the syringe are balanced is a value obtained by subtracting the lowering in pressure due to transpiration of water vapor. Thus, the balancing pressure can be estimated to be higher than the pressure relevant to the boundary between disappearance of bubbles and non-disappearance of bubbles.

In considering the condition inside the syringe, it is to be noted that the inside of bubbles is filled with saturated water vapor. To therefore obtain the pressure of the gas components such as oxygen and nitrogen molecules in the bubbles, the pressure of saturated water vapor must be subtracted from the internal pressure of the syringe. In order that the corning-in and coming-out of oxygen and nitrogen molecules through the resin serving as a partition between the inside and the outside of the syringe are balanced, it is considered necessary for the respective gas partial pressures in the inside of the syringe to be equal to the corresponding gas partial pressures in the outside of the syringe. This means that when the water inside the syringe is pressurized by a value equal to the saturated water vapor pressure, the partial pressures of the oxygen and nitrogen gases in the inside of the syringe are balanced with those in the outside of the syringe. In fact, saturated water vapor pressure is 12.2 kPa at 50° C., which satisfies the results shown in FIG. 2. Specifically, in the case of storing and distributing the drug containers of the present invention by maintaining them at a temperature of not higher than room temperature, prevention of generation of bubbles and removal of generated bubbles can be achieved even with a lower container internal pressure, since the saturated water vapor pressure at room temperature of 20° C. is 2.3 kPa. However, during normal distribution, the drug containers may be momentarily exposed to elevated temperatures. Taking this into account, it is preferable to adopt a condition in which bubbles would not be generated and bubbles, if generated, can be removed at a temperature of around 50° C. Thus, it is preferable to maintain a syringe internal pressure of not less than 10 kPa.

The time of two days required for disappearance of bubbles, at preset pressures of 27 kPa and 30 kPa, is sufficiently short as compared with the time necessary for getting lot control data for guarantee, distribution thereof, or the like after the manufacture of the products. This shows that there is no problem on a practical-use basis. One preferred minimum storage period and associated pressure for storing the container to achieve bubble disappearance is at least one week at a pressure of at least 27 kPa.

In addition, this experimental example was started from a condition in which bubbles were highly liable to be generated. Therefore, it is clear that if a contrivance of filling the liquid drug into the drug container after degassing the liquid drug or in a bubble-free state is additionally adopted, the syringe used in this experimental example ensures that generation of bubbles is prevented, also during distribution period, even by pressurizing to a pressure of about 10 kPa.

### Experimental Example 3

Disappearance of bubbles during storage under pressurizing to 25 kPa was confirmed by the same method as in Experimental Example 2, except that the storage temperature was changed to room temperature and commercial syringes of various capacities (5 ml: Vitaject, a product by Terumo Corporation, 10 ml: Terumo Syringe, a product by Terumo Corporation, 20 ml: KC1 Mediject, a product by Terumo Corporation) were used.

The materials constituting the components of each syringe were polypropylene for the outer tube, and a styrene elastomer-containing olefin elastomer for the gasket. The results are shown in Table 3.

TABLE 3
Disappearance of bubbles in polypropylene syringes of various capacities

| | At pressure confirmation and correction | | | |
|---|---|---|---|---|
| Syringe | after storage at room temperature | | | Confirmation of |
| Size/Volume | Max-P | Min-P | Av | disappearance of |
| at 25 kPa | (kPa) | (kPa) | (kPa) ± SD | bubbles |
| 5 ml Syringe | 17.1 | 12.2 | 14.9 ± 2.5 | Disappeared in 3 days |
| 10 ml Syringe | 10.4 | 5.0 | 8.1 ± 2.5 | Disappeared in 6 days |
| 20 ml Syringe | 21.0 | 17.7 | 19.2 ± 1.7 | Disappeared in 5 days |

From the results of Experimental Example 3, bubbles were confirmed in all syringes, upon the process of a temperature rise from a 4° C. cold storage state to room temperature. It was thereby confirmed that in syringes different in capacity and shape, bubbles formed from gases dissolved during cold storage can be removed within one week in the condition of storage at room temperature.

The 10 ml syringe was the same as that used in Experimental Example 2. In this case, with the temperature lowered from 50° C. to room temperature (about 20° C.), the time necessary for disappearance of bubbles was prolonged to about three times the original value.

In other words, while a higher temperature is more effective in removing bubbles, it was found possible here to remove bubbles sufficiently effectively even during storage at room temperature.

### Experimental Example 4

A 5 ml syringe used for a commercial prefilled syringe (Vitaject, a product by Terumo Corporation), using cyclic polyolefin as a material of the outer tube, was prepared. Using the same measuring apparatus as used in Experimental Example 1, the syringe was filled with cold-stored water (having been stored at 4° C.), the pressure was set at 25 kPa, and the water-filled syringe was left to stand in a 50° C. oven for one hr. The gasket was formed of butyl rubber.

As a result, the pressure rose to 88.7 kPa, but bubbles were not observed.

From the results of Experimental Example 4, it was found that also in the case of a syringe formed using cyclic polyolefin for the outer tube, generation of bubbles can be prevented if the pressure loaded on the liquid drug is about 90 kPa at maximum.

### Experimental Example 5

Using the same prefilled syringes and measuring apparatus as those used in Experimental Example 4, the regulation ports of the syringes were kept open for one hr after placing the syringes in a 50° C. oven, to lower the pressure to zero, with the result of generation of bubbles. Thereafter, the pressure was regulated to 25 kPa for one syringe and 50 kPa for the other syringe. For each of the syringes, the pressure was confirmed and regulated once a day, and variation of bubbles with time was observed.

From the results of Experimental Example 5, it was confirmed that at the pressure of 25 kPa, the bubbles would not disappear in two weeks but that at the pressure of 50 kPa, the bubbles disappeared within one week. Besides, after the disappearance of the bubbles, the bubble-free syringe was left to stand at 50° C. and 50 kPa for two days, then the pressure was returned to the atmospheric pressure, and the syringe was left to stand in that condition for one hr. Consequently, bubbles were not generated.

From the foregoing, it was found that, even with differences in materials for syringe and gasket and the like, fine bubbles generated at the time of filling respective syringes with a liquid drug can be removed, though there are differences in the pressure and time required. Each of the disclosed embodiments of the drug container includes a pressurizing member which operates as a means for pressing the seal toward the closed end of the tubular member to apply pressure to the liquid drug in the tubular member or container to eliminate bubbles in the liquid drug and inhibiting or preventing formation of bubbles in the liquid drug. The pressing means preferably maintains an internal pressure of the liquid drug in the outer tube at 10 kPa or more, preferably between 10 kPa and 90 kPa. These pressures referenced here refer to pressures above atmospheric, meaning the liquid drug is pressurized in the outer tube or container at a pressure of 10 kPa or more above atmospheric, preferably between 10 kPa and 90 kPa above atmospheric.

Set forth below is a listing and associated description of reference numerals illustrated in the drawing figures.
101 Prefilled syringe (drug container)
102 Outer tube
103 Plunger
104 Cap
105 Spring member
107 Lock part
108 Flange
109, 201, 209 Gasket
110 Tip opening
111 Rear end opening
112 Syringe side end part
113 Central part
114 Intermediate part
115 Curved part
116 Presser part
117 Terminal end part
118 Rugged part
119 Pressing part
120 Hole
200, 220 Cartridge
202 Glass vial
203 Aluminum cap
204 Rubber septum
205, 210 Fixing cap
206 Rib
207, 208 Spring member
211 Tip part
212 Rear end part
213, 214 Flange joint
501 Measuring syringe
502 Pressure gauge
503 Pressure regulation port
504 Plunger fixing pin
505 Luer connector

The detailed description above describes embodiments of the container disclosed here. The invention is not limited, however, to the precise embodiments and variations described and illustrated above. Various changes, modifications and equivalents could be effected by one skilled in the art without departing from the spirit and scope of the invention as defined in the appended claims. It is expressly intended that all such changes, modifications and equivalents which fall within the scope of the claims are embraced by the claims.

What is claimed is:

1. A drug container comprising: a tubular member possessing an interior, a rear end pat and a tip end part, the tip end part being a closed tip end part, a seal positioned in the interior of the tubular member and slidably engaging an inner surface of the interior tubular member in a liquid-tight manner, a liquid drug in the interior of the tubular member wholly between the closed tip end part and the seal, at least a part of the tubular member being a resin part which is continuously in contact with the liquid drug, and means for pressing the seal in a direction toward the closed tip end part of the tubular member to maintain the liquid drug in the interior of the container in a pressurized state of at least 10 kPa so the liquid drug is in a substantially bubble-free state during storage.

2. The drug container according to claim 1, wherein the tubular member includes an enlarged flange at the rear end part of the tubular member, and including a plunger extending outwardly from the rear end of the tubular member, the plunger having a tip end part and a rear end part, the tip end part of the plunger being connected to the seal, the rear end part of the plunger having an enlarged pressing part; and the means for pressing comprising an elastic member removably mounted on the tubular member and the plunger to urge the pressing part toward the flange.

3. The drug container according to claim 1, wherein the tubular member includes an enlarged flange at the rear end part of the tubular member, and including a plunger extending outwardly from the rear end of the tubular member, the plunger having a tip end part and a rear end part, the tip end part of the plunger being connected to the seal, the rear end part of the plunger having an enlarged pressing part; and the means for pressing is a removable elastic member having one portion contacting a surface of the flange which faces axially toward the tip end part of the tubular member and another portion contacting a surface of the pressing part of the plunger facing axially away from the tip end part of the plunger, the elastic member applying a compressive force urging the pressing part toward the flange.

4. The drug container according to claim 1, wherein the means is comprised of a cap and a part of the seal, a part of the cap being positioned in the part of the seal, the cap also engaging a rib at the rear end part of the tubular member to fix the cap in position relative to the tubular member.

5. The drug container according to claim 1, wherein the means is comprised of a spring and a cap, the spring being positioned between the cap and the seal, the cap engaging a rib at the rear end part of the tubular member to fix the cap in position relative to the tubular member.

6. A drug container comprising: a container possessing an interior enclosing a liquid drug, at least a part of the container being a resin part in contact with the liquid drug, a pressurizing member mounted in the interior of the container, the pressurizing member maintaining the liquid drug in the interior of the container in a pressurized state and being removable from the container, and the liquid drug in the interior of the container being in a substantially bubble-free state.

7. The drug container according to claim 6, wherein the drug container comprises an outer tube having a tip end and a rear end, and a seal in the interior of the container and slidable on an inner surface of the outer tube in an axial direction of the outer tube, the tip end being a sealed tip end that is sealed in a liquid-tight manner, at least one of the seal and the outer tube being the resin part, and the liquid drug is in the outer tube wholly between the seal and the sealed tip end.

8. The drug container according to claim 7, wherein the outer tube includes an enlarged flange at the rear end part of the outer tube, and including a plunger extending outwardly from the rear end of the outer tube, the plunger having a tip end part and a rear end part, the tip end part of the plunger being connected to the seal, the rear end part of the plunger having an enlarged pressing part; and the pressurizing member is an elastic member removably mounted on the flange of the outer tube and the pressing part of the plunger to apply a compressive force between the flange and the pressing part.

9. The drug container according to claim 7, wherein the outer tube includes an enlarged flange at the rear end part of the outer tube, and including a plunger extending outwardly from the rear end of the outer tube, the plunger having a tip end part and a rear end part, the tip end part of the plunger being connected to the seal, the rear end part of the plunger having an enlarged pressing part; and the pressurizing member is a removable elastic member having one portion contacting a surface of the flange which faces axially toward the tip end part of the outer tube and another portion contacting a surface of the pressing part of the plunger facing axially away from the tip end part of the plunger, the elastic member applying a compressive force urging the pressing part toward the flange.

10. The drug container according to claim 6, wherein the drug container comprises an outer tube having a tip end and a rear end, and a seal positioned in the interior of the container and slidable on an inner surface of the outer tube in an axial direction of the outer tube, the tip end being sealed in a liquid-tight manner by a sealing member, at least one of the seal and the outer tube being the resin part, and the liquid drug is in the outer tube wholly between the sealing member and the seal.

11. The drug container according to claim 10, wherein the pressurizing member is comprised of a cap and a part of the seal, a part of the cap being positioned in the part of the seal, the cap engaging the rear end part of the outer tube to fix the cap in position relative to the outer tube.

12. The drug container according to claim 10, wherein the pressurizing member is comprised of a spring and a cap, the spring being positioned between the cap and the seal, the cap engaging the rear end part of the outer tube to fix the cap in position relative to the outer tube.

13. The drug container according to claim 6, wherein the pressurizing member maintains an internal pressure of the liquid drug in the outer tube at 10 kPa to 90 kPa.

14. A method of storing a liquid drug in a drug container to eliminate bubbles and inhibit bubble formation during storage, the drug container comprising a container possessing an interior enclosing a liquid drug, with at least a part of the container being a resin part in contact with the liquid drug, and a seal positioned in a liquid tight manner in the interior of the container and slidable along an inner surface of the interior of the container, the method comprising: pressurizing the interior of the container containing the liquid drug so the liquid drug in the interior of the container is maintained in a pressurized state to eliminate bubbles and inhibit bubble formation during storage; and storing the drug container containing the liquid drug in the pressurized state.

15. The method according to claim 14, wherein the container includes a closed tip end part and a rear end part, and the pressurizing of the interior of the container comprising pressing a plunger toward the closed tip end part of the container, the plunger being fixed to the seal member and extending outwardly from the rear end part of the container.

16. The method according to claim 15, wherein the container includes an enlarged flange, and the plunger possesses a rear end part having an enlarged pressing part, and wherein the plunger is pressed toward the tip end part by an elastic member having one portion contacting a surface of the flange and another portion contacting a surface of the pressing part of the plunger, the elastic member applying a compressive force urging the pressing part toward the flange.

17. The method according to claim 14, wherein the pressurizing of the interior of the container comprises a cap at a rear end part of the container engaging a part of the seal to urge the seal toward the liquid drug, and the cap also engaging a rib at the rear end part of the container to fix the cap in position relative to the container.

18. The method according to claim 14, wherein the pressurizing of the interior of the container comprises the seal being urged toward the liquid drug by virtue of a cap which engages a rib at the rear end part of the container to fix the cap relative to the container and a spring positioned between the cap and the seal.
